(19) United States
(12) Patent Application Publication
(10) Pub. No.: US 2022/0033269 A1
(43) Pub. Date: Feb. 3, 2022

(54) ZEOLITE AND PREPARATION METHOD THEREFOR

(71) Applicants: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Tae Bong BYEON, Pohang-si, Gyeongsangbuk-do (KR); Keon Mok SOHN, Seoul (KR); Kiyoung KIM, Pohang-si, Gyeongsangbuk-do (KR)

(21) Appl. No.: 17/414,061

(22) PCT Filed: Jul. 22, 2019
(86) PCT No.: PCT/KR2019/009030

§ 371 Date: Jun. 15, 2021

(30) Foreign Application Priority Data
Dec. 18, 2018 (KR) 10-2018-0164386

(51) Int. Cl. C01B 39/46; C01B 39/14; C01B 39/22

(52) U.S. Cl. CPC C01B 39/46; C01B 39/14; C01P 2002/85; C01P 2002/72; C01P 2004/03; C01B 39/22

(57) ABSTRACT

Disclosed is a method of producing zeolite that includes obtaining a lithium residue including aluminosilicate from lithium ore including lithium oxide; washing the lithium residue to adjust the pH of the lithium residue; adjusting a molar ratio of silicon to aluminum (Si/Al) included in the lithium residue; preparing a hydrogel by adding an alkali material to the lithium residue; and preparing crystals by crystallizing the lithium residue in the form of a hydrogel.

### TECHNICAL FIELD

The present invention relates to zeolite and a method for producing the same. More specifically, the present invention relates to a zeolite capable of obtaining zeolite having good crystallinity by using a lithium residue prepared from lithium ore, and a method for producing the same.

### BACKGROUND ART

Zeolite (M[(Al₂O₃)ₓ(SiO₂)_{y}]_{z}H₂O) is a material used as a washing detergent, a toothpaste raw material, a catalyst for removing harmful substances of exhaust gas, and the like. The zeolite has unique applied mineral properties, that is, cation exchange properties, adsorption and molecular sieve properties, catalytic properties, dehydration and re-absorption properties, etc. and thus is utilized and applied in related industries.

Research on synthesizing the zeolite was made for the purpose of industrial application by a research team of Union Carbide in 1949, who first have succeeded in synthesizing type-A zeolite, and as the type A zeolite has been known to have excellent applied mineral properties, the zeolite synthesis increasingly has drawn interests, ensuing a lot of studies. In the 1960s, research on the zeolite has been fully activated with successful applications in the petrochemical process and emergence of new synthetic zeolites with outstanding efficacy such as type-X zeolite and type-Y zeolite in the United States.

In recent years, as the zeolite has been more widely applied, research on zeolite having new pore structures and applied mineral properties in line with demands for more diversity in the pore structures and properties of the zeolite has been made, developing about 150 types of synthetic zeolites including ZSM-5, which draws the most attentions in industrial applications.

The zeolite synthesis mostly adopts a hydrothermal synthesis method, so-called, a “hydrogel process,” under a temperature condition of room temperature to 200° C. In general, zeolite is relatively easily synthesized at a low temperature without a particular pressure condition. Synthetic zeolite has excellent performance and efficacy as well as various pore properties but is somewhat more difficult to actually apply than natural zeolite, which is less expensive, in terms of price.

Accordingly, efforts to develop an inexpensive synthesis method of homogeneously synthesizing zeolite having excellent properties are currently being made. For example, a method of using natural materials, which are less expensive than conventional reagent type materials (sodium silicate, sodium aluminate, silica gel, etc.), that is, silicate minerals having an appropriate composition for the zeolite synthesis as a raw material is being examined. The studies on the zeolite synthesis using the natural minerals have been mainly focused on china clay, kaolin, and volcanic vitreous rocks.

In addition, research on using various by-products generated in a large amount during industrial processes instead of the natural minerals that lack resources is continuously being made.

### DISCLOSURE

A zeolite capable of obtaining zeolite having good crystallinity by using a lithium residue prepared from lithium ore and a method for producing the same are provided.

A method of producing zeolite according to an embodiment of the present invention includes obtaining a lithium residue including aluminosilicate from lithium ore including lithium oxide; washing the lithium residue to adjust the pH of the lithium residue; adjusting a molar ratio of silicon to aluminum (Si/Al) included in the lithium residue; preparing a hydrogel by adding an alkali material to the lithium residue; and preparing crystals by crystallizing the lithium residue in the form of a hydrogel.

The obtaining of the lithium residue may include heat-treating the lithium ore; pulverizing the heat-treated lithium ore; precipitating lithium sulfate from the pulverized lithium ore; and leaching and separating the lithium sulfate into water.

In the heat-treating of the lithium ore, the lithium ore may be heat-treated at a temperature of 900 to 1200° C.

In the obtaining of the lithium residue, the lithium residue may include 20 to 30 wt % of alumina (Al₂O₃), 60 to 70 wt % of silica (SiO₂), 10 wt % or less of at least one of iron oxide (Fe₂O₃), calcium oxide (CaO), sodium oxide (Na₂O), and potassium oxide (K₂O) based on total 100 wt %.

In the adjusting of the pH of the lithium residue, the lithium residue may be washed to remove the sulfate ion (SO₄²⁻) from the lithium residue.

In the adjusting of the pH of the lithium residue, the pH of the lithium residue may be adjusted to 6 to 8.

In the adjusting of the molar ratio of silicon to aluminum (Si/Al), the molar ratio of silicon to the aluminum (Si/Al) may be adjusted to 0.75 to 3.0 by adding an alumina supplement material to the lithium residue.

The alumina supplement material may include one or more of alumina hydrate (Al(OH)₃ and sodium aluminate (NaAlO₂).

In the adding of an alkali material to the lithium residue, the alkali material may be a sodium hydroxide aqueous solution having a concentration of 1.0 to 6.0 M.

In the preparing of the crystals, the lithium residue may be crystallized at a temperature of 60 to 100° C.

In the preparing of the crystals, the lithium residue may be crystallized for at least 12 hours.

In the preparing of the crystals, the lithium residue in the form of a hydrogel may be crystallized while stirring at 300 to 600 rpm.

The method may further include filtering the crystals; and washing and drying the filtered crystals after the preparing of the crystals.

A zeolite according to an embodiment of the present invention may have a crystal phase including at least one an A-type zeolite, an X-type zeolite, and a P-type zeolite and may include 0.005 wt % or less (excluding 0 wt %) of hydroxysodalite (Na₈(AlSiO₆)₄(OH)₂), analcime (NaAlSi₂O₆.H₂O), and SOD based on total 100 wt %.

According to the method of producing zeolite of an embodiment of the present invention, it is possible to produce zeolite having good crystallinity and no impurities incorporated therein.

The produced zeolite may be used as a washing detergent, an adsorbent, a catalyst for removing harmful gases, and the like.

### DESCRIPTION OF THE DRAWINGS

FIG. 1 is a view showing a crystal structure transition of a mineral and a crystal structure of lithium residue in a heat-treating process, a sulfuric acid-roasing, and a water leaching process of a lithium ore in a method of producing zeolite according to an embodiment of the present invention.

FIG. 2 is a graph showing XRD analysis results of lithium residue generated in a solid-liquid separation process after water leaching in a method of producing zeolite according to an embodiment of the present invention.

FIG. 3 is a graph showing the particle size distribution of lithium residue generated in a solid-liquid separation process after water leaching in a method of producing zeolite according to an embodiment of the present invention.

FIG. 4 is a photograph showing the appearance of a lithium residue recovered from a filter press in a method of producing zeolite according to an embodiment of the present invention.

FIG. 5 is a photograph showing SEM and EDX analyses of particles having fine holes formed on the surface of particles and particles with a clean cleavage surface in a lithium residue in a method for preparing a zeolite according to an embodiment of the present invention.

### MODE FOR INVENTION

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The technical terms used herein are to simply mention a particular embodiment and are not meant to limit the present invention. An expression used in the singular encompasses an expression of the plural, unless it has a clearly different meaning in the context. As used in the specification, the meaning of “comprising” specifies a specific characteristic, region, integer, step, action, element and/or component, but does not exclude the presence or addition of another characteristic, region, integer, step, action, element and/or component.

When referring to a part as being “on” or “above” another part, it may be positioned directly on or above another part, or another part may be interposed therebetween. In contrast, when referring to a part being “directly above” another part, no other part is interposed therebetween.

Unless otherwise defined, all terms used herein, including technical or scientific terms, have the same meanings as those generally understood by those with ordinary knowledge in the field of art to which the present invention belongs.

Terms defined in commonly used dictionaries are further interpreted as having meanings consistent with the relevant technical literature and the present disclosure, and are not to be construed as having idealized or very formal meanings unless defined otherwise.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

### Method of Producing Zeolite

A method of producing zeolite according to an embodiment of the present invention includes obtaining a lithium residue including aluminosilicate from lithium ore including lithium oxide, washing the lithium residue to adjust the pH of the lithium residue, adjusting a molar ratio of silicon to aluminum (Si/Al) included in the lithium residue, preparing a hydrogel by adding an alkali material to the lithium residue, and preparing crystals by crystallizing the lithium residue in the form of a hydrogel.

After the preparing the crystals, filtering the crystals and washing and drying the filtered crystals may be further included.

First, in the obtaining of the lithium residue, a lithium residue including aluminosilicate is obtained from a lithium ore including lithium oxide. The lithium ore may include 1.5 wt % or more of lithium oxide (Li₂O), and the main mineral phase may be spodumene (Li₂OAl₂O₃4SiO₂, LiAl₂Si₂O₆). The aluminosilicate (Al₂O₃4SiO₂, AlSi₂O₆) may be a compound composed mainly of alumina (Al₂O₃) and silica (SiO₂).

Specifically, the obtaining of the lithium residue may include heat-treating the lithium ore, pulverizing the heat-treated lithium ore, precipitating lithium sulfate from the pulverized lithium ore, and leaching and separating the lithium sulfate into water.

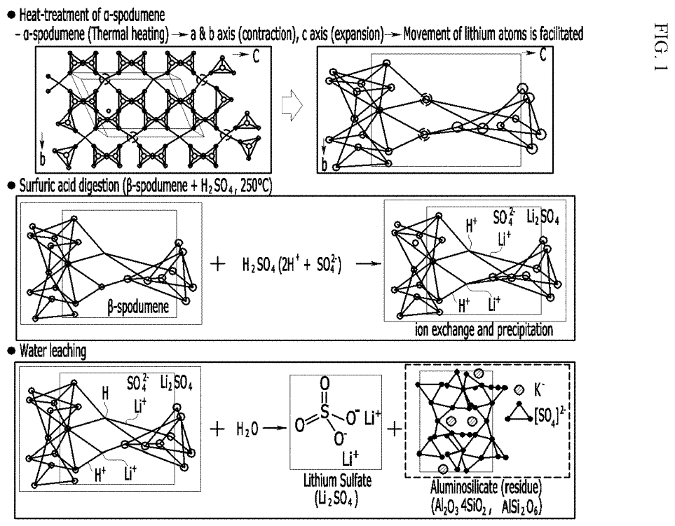

The lithium ore is heat-treated at a temperature of 900 to 1200° C. Accordingly, the a-axis and b-axis contract and the c-axis expands in α-spodumene contained in the lithium ore as shown in FIG. 1, so that it can be transferred to the β-spodumene form. Therefore, the movement of lithium atoms may be facilitated.

After pulverizing the heat-treated lithium ore, lithium sulfate may be precipitated from the pulverized lithium ore. The lithium ore may be leached into sulfuric acid. Accordingly, H⁺ ions dissociated from sulfuric acid are ion-exchanged at the Li⁺ ion site of the lithium ore, the ion-exchanged Li⁺ ions are combined with the dissociated SO₄²⁻ ions, and a precipitation reaction proceeds to precipitate lithium sulfate (Li₂SO₄).

A lithium residue may be prepared by leaching the precipitated lithium sulfate (Li₂SO₄) with water and then performing solid-liquid separation. The lithium sulfate (Li₂SO₄) is dissolved in water and leached, whereas aluminosilicate (Al₂O₃4SiO₂, AlSi₂O₆) is not soluble in water, and remains in the form of a solid compound to constitute a lithium residue.

Specifically, the lithium residue may include 20 to 30 wt % of alumina (Al₂O₃), 60 to 70 wt % of silica (SiO₂), 10 wt % or less of at least one of iron oxide (Fe₂O₃), calcium oxide (CaO), sodium oxide (Na₂O), and potassium oxide (K₂O) based on total 100 wt %.

The lithium residue has a crystal phase composed of aluminosilicate (Al₂O₃4SiO₂, AlSi₂O₆), silica (SiO₂), and albite, and the like. The average particle size may be less than or equal to 500 μm and the volume and packing density may be about 0.88 and 1.28, respectively.

The lithium residue may include particles having an amorphous form, and having fine holes or the like formed on the surface due to acid leaching of lithium components on the surface, and particles having a clean cleavage surface.

Next, in the adjusting of the pH of the lithium residue, the pH of the lithium residue may be adjusted by washing the lithium residue with water. Since the lithium residue uses an excessive amount of sulfuric acid during roasing, the unreacted sulfuric acid is dissolved by leaching with water and is included in the lithium residue, and the lithium residue may become acidic because it remains in the lithium residue.

When an acidic lithium residue is used as a composition for zeolite production as it is, an alkali substance for hydrogel generation may be consumed first, and sulfate ions remaining in the lithium residue form sodium sulfate, and resultantly it may interfere with a reaction of generating the hydrogel.

Therefore, the pH of the lithium residue may be adjusted to 6 to 8 by sufficiently washing the acidic lithium residue with water to remove sulfate ions (SO₄²⁻) from the lithium residue. That is, the pH of the lithium residue may be formed in a neutral region.

Next, in the adjusting of the molar ratio of silicon to aluminum (Si/Al), an alumina supplement material is added to adjust the molar ratio of silicon to aluminum (Si/Al) contained in the lithium residue. Through the adjustment, in addition to the crystal phases of the A-type zeolite, X-type zeolite, and P-type zeolite, hydroxysodalite (Na₈(AlSiO₆)₄(OH)₂) and analcime (NaAlSi₂O₆.H₂O) are prevented from being excessively mixed and produced.

Specifically, the molar ratio of silicon to aluminum (Si/Al) may be adjusted to 0.75 to 3.0, and the alumina supplement material may include at least one of alumina hydrate (Al(OH)₃) and sodium aluminate (NaAlO₂). The crystal phases of A-type zeolite, X-type zeolite, and P-type zeolite may be prepared by adjusting the molar ratio of silicon to aluminum (Si/Al) to be 0.75 to 3.0.

Next, in the adding of an alkali material to the lithium residue, the alkali material may be added to the lithium residue to prepare the lithium residue in a hydrogel form. Specifically, the alkaline material may be an aqueous sodium hydroxide solution having a concentration of 1.0 to 6.0 M.

Accordingly, crystal phases of A-type zeolite, X-type zeolite, and P-type zeolite having good crystallinity can be prepared. When the concentration of the alkali material is less than 1.0 M, in addition to the crystal phases of the A-type zeolite, X-type zeolite, and P-type zeolite, hydroxysodalite (Na₈(AlSiO₆)₄(OH)₂) and analcime (NaAlSi₂O₆.H₂O) are prevented from being excessively mixed and produced. On the other hand, when the concentration of the alkaline material exceeds 6.0 M, the final product may be a zeolite crystal, but hydroxysodalite, which has poor industrial applicability, may be produced in a single phase.

Next, in the preparing of the crystals, the lithium residue in the form of a hydrogel is crystallized to prepare crystals. Zeolite crystallinity may be controlled by adjusting the crystallization temperature and time, and incorporation of a material such as hydroxysodalite may be prevented.

Specifically, the lithium residue may be crystallized at a temperature of 60 to 100° C. In addition, the lithium residue may be crystallized for 12 hours or more.

When the crystallization temperature is less than 60° C., the final product may be a zeolite crystal, but an analcime that has insufficient industrial applicability due to low ion exchange capacity may be produced. On the other hand, when crystallization is performed at a temperature exceeding 100° C., hydroxysodalite may be mixed and produced in addition to the zeolite crystal phase.

Likewise, when crystallization is performed in less than 12 hours, the final product may be a zeolite crystal, but an analcime that has insufficient industrial applicability due to low ion exchange capacity may be produced. Therefore, a zeolite crystal phase having good crystallinity may be prepared by adjusting the crystallization time to a range of 12 hours or more.

On the other hand, the lithium residue in the form of a hydrogel may be crystallized while stirring at 300 to 600 rpm. When crystallization while stirring at a stirring rate of less than 300 rpm, the final product may belong to the zeolite crystal, but an analcime that has insufficient industrial applicability due to low ion exchange capacity may be produced. On the other hand, when crystallized while stirring at a stirring rate exceeding 600 rpm, analcime and SOD may be mixed and produced.

Next, in the washing and drying of the filtered crystals, excess sodium hydroxide (NaOH) may be removed by sufficient washing to adjust the pH of the product to a neutral region. This is because Na ions remaining in the product due to insufficient washing with water act as a cause of deteriorating the quality and performance of the zeolite.

### Zeolite

A zeolite according to an embodiment of the present invention may have a crystal phase including at least one an A-type zeolite, an X-type zeolite, and a P-type zeolite and may include 0.005 wt % or less (excluding 0 wt %) of hydroxysodalite (Na₈(AlSiO₆)₄(OH)₂), analcime (NaAlSi₂O₆.H₂O), and SOD based on total 100 wt %.

According to the method of producing the zeolite according to an embodiment of the present invention, a lithium residue including aluminosilicate is obtained from lithium ore including lithium oxide, the lithium residue is washed to adjust the pH of the lithium residue, a molar ratio of silicon to aluminum (Si/Al) included in the lithium residue is adjusted, an alkali material is added to the lithium residue to prepare a hydrogel, and crystallization may be performed to prepare crystals.

Accordingly, zeolite may have a crystal phase including at least one of A-type zeolite, X-type zeolite, and P-type zeolite, and the content of materials such as hydroxysodalite, analcime, and SOD may be adjusted to be 0.005 wt % or less. The 0.005 wt % may be an impurity level and may mean an amount that is hardly present in the zeolite.

In addition, the descriptions of the lithium residue, the molar ratio of silicon to aluminum (Si/Al), the alkali material, crystallization, and zeolite may be replaced with the aforementioned descriptions of the method of producing zeolite.

Hereinafter, specific examples of the present invention are described. However, the following examples are only specific examples of the present invention, and the present invention is not limited to the following examples.

### Examples

(1) Preparation of Lithium Residue Using Lithium Ore

An Australian Galaxy ore with a lithium oxide (Li₂O) content of 6 wt %, which was concentrated from a lithium ore with a lithium oxide (Li₂O) content of 1.5 wt % by removing feldspar and mica, etc. through flotation, etc., was used.

Subsequently, the ore was heat-treated at 1000° C. to transfer it into β-spodumene and then, pulverized to adjust its particle size and thus improve reactivity in the subsequent process. After adding sulfuric acid at a concentration of 95% 3 times by weight thereto and mixing them, the particle size-adjusted β-spodumene was roasted with the sulfuric acid at 250° C. for 1 hour.

After the sulfuric acid-roasting, water was 5 times by weight added thereto and then, stirred for 1 hour for leaching, and then, a filter press was used to separate solid-liquid and thus recover a lithium residue.

The lithium residue recovered from the filter press was analyzed with respect to components and contents by using XRF and ICP, and the results are shown in Tables 1 and 2.

TABLE 1

| Com- | | | | | | | | | | | | | | | |
|---|---|---|---|---|---|---|---|---|---|---|---|---|---|---|---|
| ponent | Li₂O | Al₂O₃ | SiO₂ | CaO | Na₂O | K₂O | P₂O₅ | Fe₂O₃ | CoO | MnO | Cr₂O₃ | MgO | CuO | NiO | TiO₂ |
| Content | Anal- | 25.8 | 66.2 | 0.4 | 0.1 | 0.5 | 0.1 | 1.6 | — | 0.1 | 0.03 | 0.1 | — | 0.01 | 0.04 |
| (wt %) | ysis | | | | | | | | | | | | | | |
| | impos- | | | | | | | | | | | | | | |
| | sible | | | | | | | | | | | | | | |

TABLE 2

| Com- | | | | | | | | | | | | | | |
|---|---|---|---|---|---|---|---|---|---|---|---|---|---|---|
| ponent | Li | Al | Si | Ca | Na | K | P | Fe | Co | Mn | Cr | Mg | Cu | Ni |
| Con- | 0.51 | 12.59 | 28.41 | 0.32 | 0.4 | 0.6 | 0.063 | 1.11 | <0.005 | 0.11 | 0.023 | 0.21 | <0.005 | 0.01 |
| tent | | | | | | | | | | | | | | |
| (wt %) | | | | | | | | | | | | | | |

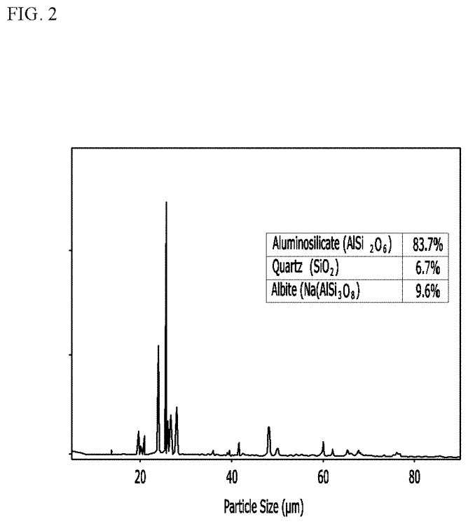

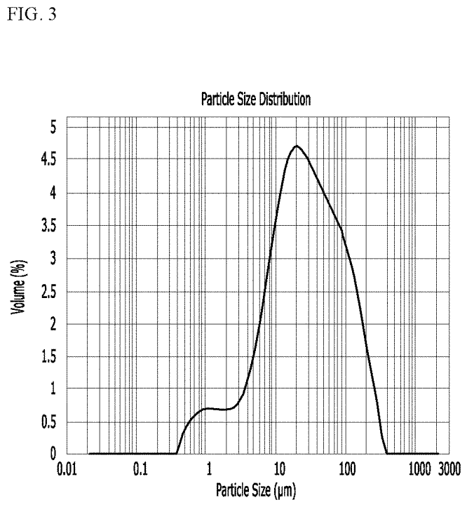

As shown in Tables 1 and 2 and FIGS. 2 and 3, the lithium residue included alumina (Al₂O₃): about 26 wt %, silica (SiO₂): about 66 wt %, iron oxide (Fe₂O₃): about 1.6 wt %, and at least one among calcium oxide (CaO), sodium oxide (Na₂O), and potassium oxide (K₂O): about 0.4 wt % or less and had a crystal phase composed of aluminosilicate (Al₂O₃4SiO₂, AlSi₂O₆), silica (SiO₂), Albite, and the like, an average particle size of less than or equal to 500 μm, and a volume and packing density of about 0.88 and 1.28, respectively.

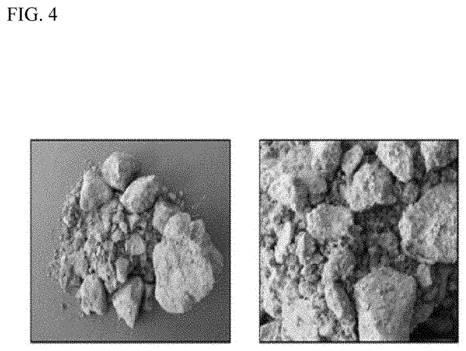

As shown in FIG. 4, the lithium residue recovered from the filter press exhibited a state that very fine particles were aggregated, a moisture content of about 39%, and pH of about 3.1 which was weakly acidic.

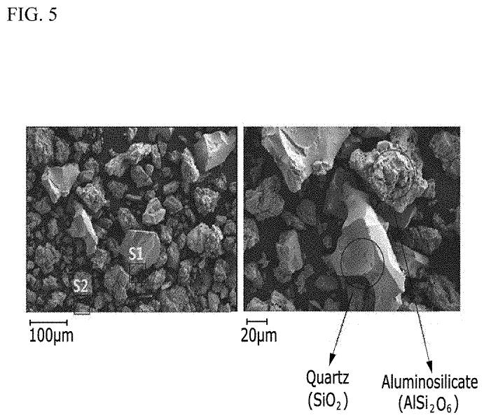

As shown in FIG. 5, fly ash and the lithium residue exhibited very similar values in terms of the components and the contents of main components, but the contents of alkali metal components such as calcium oxide (CaO), magnesium oxide (MgO), and iron oxide (Fe₂O₃) were somewhat higher in the fly ash raw material, and the content of an acidic component such as silica (SiO₂) was about 10% more found in the lithium residue.

On the contrary, regarding a neutral component such alumina (Al₂O₃), the two raw materials exhibited almost similar contents. The fly ash had a spherical particle shape and a particle size within the range of about 5 to 600 μm, but the lithium residue, as shown in FIG. 5, had an amorphous particle shape and consisted of particles having fine holes on the surfaces due to the acid leaching of the lithium (Li) components and particles having clean cleavage surfaces.

(2) pH Adjustment of Lithium Residue

[Experimental Example 1] 15 Kg of distilled water was added to 3 kg of the lithium residue prepared in the experiment to adjust a solid-liquid ratio (water/lithium residue) into 5/1 and then, stirred at 500 rpm for 3 hours and filtered, which was three times repeated for three times washing. The pH of the washed residue was measured according to the pH measurement standard of the waste process test method, and the results are shown in Table 3.

[Experimental Example 2] It was carried out under the same conditions as in Experimental Example 1, except that the washing operation was carried out only once. The pH of the washed lithium residue was measured, and the results are shown in Table 3.

[Experimental Example 3] It was carried out under the same conditions as in Experimental Example 1, except that the washing operation was carried out only twice. The pH of the washed lithium residue was measured, and the results are shown in Table 3.

TABLE 3

| | Solid-liquid ratio | | Lithium |
|---|---|---|---|
| | (weight ratio of lithium | Washing | residue |
| | residue/water) | (times) | (pH) |
| Experimental Example 1 | 1/5 | 3 | 6.08 |
| Experimental Example 2 | 1/5 | 1 | 3.23 |
| Experimental Example 3 | 1/5 | 2 | 3.84 |

In addition, the components and contents of the samples prepared by once, twice, and three times washing the lithium residue were analyzed by using ICP, and the results are shown in Table 4.

TABLE 4
ICP Analysis

| Samples | | Li | Al | Si | Ca | Na | K | P | Fe |
|---|---|---|---|---|---|---|---|---|---|
| 1^{st} washing | Top (dispersion) | 0.077 | 13.62 | 30.93 | 0.11 | 0.087 | 0.22 | 0.061 | 0.65 |
| | Bottom (precipitation) | 0.13 | 12.32 | 30.95 | 0.37 | 0.39 | 0.77 | 0.040 | 1.09 |
| 2^{nd} washing | Top (dispersion) | 0.088 | 13.54 | 31.07 | 0.13 | 0.11 | 0.26 | 0.059 | 0.68 |
| | Bottom (precipitation) | 0.17 | 11.99 | 31.27 | 0.44 | 0.53 | 0.93 | 0.037 | 1.24 |
| 3^{rd} washing | Top (dispersion) | 0.083 | 13.31 | 30.28 | 0.11 | 0.092 | 0.22 | 0.062 | 0.66 |
| | Bottom (precipitation) | 0.14 | 12.51 | 31.37 | 0.37 | 0.42 | 0.80 | 0.042 | 1.08 |
| | Mixing | 0.14 | 12.64 | 31.41 | 0.32 | 0.34 | 0.60 | 0.051 | 1.00 |

| Samples | | Co | Mn | Cr | Mg | Cu | Ni |
|---|---|---|---|---|---|---|---|
| 1^{st} washing | Top (dispersion) | <0.001 | 0.070 | 0.002 | 0.088 | 0.0011 | 0.003 |
| | Bottom (precipitation) | <0.001 | 0.096 | 0.008 | 0.27 | 0.0011 | 0.003 |
| 2^{nd} washing | Top (dispersion) | <0.001 | 0.073 | 0.002 | 0.10 | <0.001 | 0.002 |
| | Bottom (precipitation) | <0.001 | 0.11 | 0.008 | 0.34 | 0.0011 | 0.002 |
| 3^{rd} washing | Top (dispersion) | <0.001 | 0.071 | 0.002 | 0.092 | 0.0050 | 0.001 |
| | Bottom (precipitation) | <0.001 | 0.098 | 0.006 | 0.28 | 0.0083 | 0.002 |
| | Mixing | <0.001 | 0.091 | 0.005 | 0.25 | <0.001 | 0.002 |

As shown in Table 3, in Experimental Example 1, the lithium residue prepared by three times repeating the washing under the solid/liquid ratio condition of (lithium residue/water weight ratio) of ⅕ had pH of 6.08, which reached a neutral region. The reason is that through the repetitive washings, an excessive amount of the non-reaction sulfuric acid solution remaining in the lithium residue was removed. On the contrary, Experimental Examples 2 and 3 in which the washing was only once or twice performed exhibited that pH of the lithium residues was 3.23 and 3.84, respectively. The results showed that sulfuric acid still remained in the lithium residues.

Accordingly, acidic lithium residue was sufficiently washed to remove sulfuric acid ions (SO₄²⁻) from the lithium residue and thus adjust pH of the lithium residue into the neutral region.

As shown in Table 4, when the components and contents of the lithium residue depending on the number of washings were examined, there was almost no change depending on the number of washings. Accordingly, in order to use a lithium residue produced during the process as a raw material for producing zeolite, it is very important to sufficiently wash the lithium residue to minimize sulfuric acid ions (SO₄²⁻) present therein and thus adjust pH of the lithium residue into a neutral region.

(3) Adjustment of Molar Ratio of Silicon to Aluminum (Si/Al)

[Experimental Example 4] The washed lithium residue according to Experimental Example 1 included an aluminum (Al) component of 12.6 mol and a silicon (Si) component of 31.4 mol. Herein, sodium aluminate (NaAlO₂) as an alumina supplement material was added to 40 g of the lithium residue in the neutral pH region in order to adjust a molar ratio of Si/Al in the lithium residue into 0.75.

The component-adjusted lithium residue was put in a 2 L glass reactor, and 1200 ml of a 2.5 M NaOH solution (addition amount: NaOH 30 ml/lithium residue g) was added thereto and then, stirred to prepare slurry where the lithium residue raw material was uniformly dispersed. Subsequently, the uniformly-dispersed slurry was stirred at room temperature for 1 hour to prepare hydrogel.

The hydrogel was heated up to 90° C. and then, crystallized, while stirred at 500 rpm for 24 hours at the same temperature. Subsequently, the resultant was filtered to separate solid-liquid, repetitively washed until the pH became 9, and sufficiently dried at 105° C., obtaining a final product. The final product was analyzed with respect to a crystal phase and crystallinity with XRD, and the results are shown in Table 5.

[Experimental Example 5] It was carried out under the same conditions as in Experimental Example 4, except that the molar ratio of Si/Al in the lithium residue was adjusted to 1.0. The results are shown in Table 5.

[Experimental Example 6] It was carried out under the same conditions as in Experimental Example 4, except that the molar ratio of Si/Al in the lithium residue was adjusted to 1.5. The results are shown in Table 5.

[Experimental Example 7] It was carried out under the same conditions as in Experimental Example 4, except that the molar ratio of Si/Al in the lithium residue was adjusted to 2.0. The results are shown in Table 5.

[Experimental Example 8] It was carried out under the same conditions as in Experimental Example 4, except that the molar ratio of Si/Al in the lithium residue was adjusted to 2.25. The results are shown in Table 5.

[Experimental Example 9] It was carried out under the same conditions as in Experimental Example 4, except that the molar ratio of Si/Al in the lithium residue was adjusted to 2.5. The results are shown in Table 5.

[Experimental Example 10] It was carried out under the same conditions as in Experimental Example 4, except that the molar ratio of Si/Al in the lithium residue was adjusted to 3.0. The results are shown in Table 5.

[Experimental Example 11] It was carried out under the same conditions as in Experimental Example 4, except that the molar ratio of Si/Al in the lithium residue was adjusted to 0.5. The results are shown in Table 5.

[Experimental Example 12] It was carried out under the same conditions as in Experimental Example 4, except that the molar ratio of Si/Al in the lithium residue was adjusted to 3.5. The results are shown in Table 5.

TABLE 5

| | | Alkali | Alkali | | | |
|---|---|---|---|---|---|---|
| | | solution | addition | Crystallization | | Produced |
| | Molar | concen- | amount | temper- | | crystal |
| | ratio | tration | (NaOH | ature | Crystallization | phase/ |
| | of Si/Al | (M) | ml/residue g) | (° C.) | time (hr) | crystallinity |
| Experimental | 0.75 | 2.5 | 30 | 90 | 24 | Z-X + Z-A/Good |
| Example 4 | | | | | | |
| Experimental | 1.0 | 2.5 | 30 | 90 | 24 | Z-X/Good |
| Example 5 | | | | | | |
| Experimental | 1.5 | 2.5 | 30 | 90 | 24 | Z-P/Good |
| Example 6 | | | | | | |
| Experimental | 2.0 | 2.5 | 30 | 90 | 24 | Z-P/Good |
| Example 7 | | | | | | |
| Experimental | 2.25 | 2.5 | 30 | 90 | 24 | Z-P/Good |
| Example 8 | | | | | | |
| Experimental | 2.5 | 2.5 | 30 | 90 | 24 | Z-P/Good |
| Example 9 | | | | | | |
| Experimental | 3.0 | 2.5 | 30 | 90 | 24 | Z-P/Good |
| Example 10 | | | | | | |
| Experimental | 0.5 | 2.5 | 30 | 90 | 24 | Z-A + analcime |
| Example 11 | | | | | | |
| Experimental | 3.5 | 2.5 | 30 | 90 | 24 | Z-P + H.S |
| Example 12 | | | | | | |

* In Table 5, Z-A, Z-X, and Z-P mean A-type zeolite, X-type zeolite, and P-type zeolite, respectively.*
In Table 5, H.S and analcime mean that hydroxysodalite and analcime are mixed and produced in an amount exceeding 0.005 wt %, respectively.

As shown in Table 5, since the lithium residue alone formed no appropriate composition for producing zeolite, in Experimental Examples 4 to 10 wherein the insufficient alumina component was supplemented in order to adjust a Si/Al molar ratio within 0.75 to 3.0, final products were prepared as type-A zeolite, type-X zeolite, and type-P zeolite, which had good crystallinity.

On the contrary, in Experimental Example 11 in which the Si/Al molar ratio was adjusted as low as 0.5, a final product that analcime was mixed in addition to the type-A zeolite was obtained, but in Experimental Example 12 in which the Si/Al molar ratio was adjusted into greater than 3.0, a final product that hydroxy sodalite was mixed in addition to the type-P zeolite was produced.

Accordingly, when the neutral lithium residue were component-adjusted to control the Si/Al molar ratio within the range of 0.75 to 3.0, zeolite having good crystallinity was obtained.

(4) Adjustment of Concentration of Alkali Material

[Experimental Example 13] It was carried out under the same conditions as in Experimental Example 4, except that the concentration of the sodium hydroxide (NaOH) solution added as an alkaline material was adjusted to 1.5 M. The results are shown in Table 6.

[Experimental Example 14] It was carried out under the same conditions as in Experimental Example 4, except that the concentration of the sodium hydroxide (NaOH) solution added as an alkaline material was adjusted to 2.0 M. The results are shown in Table 6.

[Experimental Example 15] It was carried out under the same conditions as in Experimental Example 4, and the results are shown in Table 6.

[Experimental Example 16] It was carried out under the same conditions as in Experimental Example 4, except that the concentration of the sodium hydroxide (NaOH) solution added as an alkaline material was adjusted to 0.5 M. The results are shown in Table 6.

[Experimental Example 17] It was carried out under the same conditions as in Experimental Example 4, except that the concentration of the sodium hydroxide (NaOH) solution added as an alkaline material was adjusted to 1.0 M. The results are shown in Table 6.

[Experimental Example 18] It was carried out under the same conditions as in Experimental Example 4, except that the concentration of the sodium hydroxide (NaOH) solution added as an alkaline material was adjusted to 3.0 M. The results are shown in Table 6.

TABLE 6

| | Molar | Alkali | Alkali addition | | | Produced |
|---|---|---|---|---|---|---|
| | ratio | solution | amount | Crystallization | Crystallization | crystal |
| | of | concen- | (NaOH ml/ | tempera- | time | phase/ |
| | Si/Al | tration (M) | residue g) | ture (° C.) | (hr) | crystallinity |
| Experimental | 2.25 | 1.0 | 30 | 90 | 24 | Z-P/Good |
| Example 13 | | | | | | |
| Experimental | 2.25 | 1.5 | 30 | 90 | 24 | Z-P/Good |
| Example 14 | | | | | | |
| Experimental | 2.25 | 2.0 | 30 | 90 | 24 | Z-P + Z-A/ |
| Example 15 | | | | | | Good |
| Experimental | 2.25 | 2.5 | 30 | 90 | 24 | Z-P + Z-A/ |
| Example 16 | | | | | | Good |
| Experimental | 2.25 | 3.0 | 30 | 90 | 24 | Z-A/ |
| Example 17 | | | | | | Good |
| Experimental | 2.25 | 3.5 | 30 | 90 | 24 | Z-A/ |
| Example 18 | | | | | | Good |
| Experimental | 2.25 | 4.0 | 30 | 90 | 24 | Z-X + Z-A/ |
| Example 19 | | | | | | Good |
| Experimental | 2.25 | 5.0 | 30 | 90 | 24 | Z-X + Z-A/ |
| Example 20 | | | | | | Good |
| Experimental | 2.25 | 6.0 | 30 | 90 | 24 | Z-X +Z-A/ |
| Example 21 | | | | | | Good |
| Experimental | 2.25 | 0.5 | 30 | 90 | 24 | analcime + |
| Example 22 | | | | | | SOD |
| Experimental | 2.25 | 7.0 | 30 | 90 | 24 | SOD |
| Example 23 | | | | | | |
| Experimental | 2.25 | 10.0 | 30 | 90 | 24 | SOD |
| Example 24 | | | | | | |

* In Table 6, Z-A, Z-X, and Z-P mean A-type zeolite, X-type zeolite, and P-type zeolite, respectively.*
In Table 6, analcime and SOD mean that analcime and SOD are mixed and produced in an amount exceeding 0.005 wt %, respectively.

As shown in Table 6, in Experimental Examples 13 to 21 using the lithium residue component-adjusted to have a Si/Al molar ratio of 2.25 and a sodium hydroxide (NaOH) solution concentration-adjusted into 1.0 to 6.0 M as an alkali material, a final product was prepared as type-A zeolite, type-X zeolite, and type-P zeolite, which had good crystallinity.

On the contrary, in Experimental Example 22 using a sodium hydroxide (NaOH) solution adjusted to have a concentration of less than 1.0 M, a final product that analcime and SOD were mixed was produced, but when the sodium hydroxide (NaOH) solution was adjusted to have a concentration of greater than 6.0 M in Experimental Examples 23 and 24, final products that SOD was mixed were produced.

Accordingly, in the dissolution reaction of the lithium residue by adding an alkali solution thereto, when the sodium hydroxide (NaOH) solution was adjusted to have a concentration of 1.0 to 6.0 M, a zeolite crystal phase with good crystallinity was produced.

(5) Adjustment of Crystallization Temperature

[Experimental Example 25] It was carried out under the same conditions as Experimental Example 17, except that the crystallization temperature was adjusted to 60° C. The results are shown in Table 7.

[Experimental Example 26] It was carried out under the same conditions as Experimental Example 17, except that the crystallization temperature was adjusted to 70° C. The results are shown in Table 7.

[Experimental Example 27] It was carried out under the same conditions as Experimental Example 17, except that the crystallization temperature was adjusted to 80° C. The results are shown in Table 7.

[Experimental Example 28] It was carried out under the same conditions as in Experimental Example 17. The results are shown in Table 7.

[Experimental Example 29] It was carried out under the same conditions as Experimental Example 17, except that the crystallization temperature was adjusted to 100° C. The results are shown in Table 7.

[Experimental Example 30] It was carried out under the same conditions as Experimental Example 17, except that the crystallization temperature was adjusted to 50° C. The results are shown in Table 7.

[Experimental Example 31] It was carried out under the same conditions as Experimental Example 17, except that the crystallization temperature was adjusted to 110° C. The results are shown in Table 7.

[Experimental Example 32] It was carried out under the same conditions as Experimental Example 17, except that the crystallization temperature was adjusted to 120° C. The results are shown in Table 7.

TABLE 7

| | | Alkali a | Alkali addition | Crystal- | Crystal- | Produced |
|---|---|---|---|---|---|---|
| | Molar | solution | amount | lization | lization | crystal |
| | ratio of | concentration | (NaOH | tempera- | time | phase/crystal- |
| | Si/Al | (M) | ml/residue g) | ture (° C.) | (hr) | linity |
| Experimental | 2.25 | 3.0 | 30 | 60 | 24 | Z-A/Good |
| Example 25 | | | | | | |
| Experimental | 2.25 | 3.0 | 30 | 70 | 24 | Z-A/Good |
| Example 26 | | | | | | |
| Experimental | 2.25 | 3.0 | 30 | 80 | 24 | Z-A/Good |
| Example 27 | | | | | | |
| Experimental | 2.25 | 3.0 | 30 | 90 | 24 | Z-A/Good |
| Example 28 | | | | | | |
| Experimental | 2.25 | 3.0 | 30 | 100 | 24 | Z-X + Z-A + |
| Example 29 | | | | | | Z-P/Good |
| Experimental | 2.25 | 3.0 | 30 | 50 | 24 | analcime |
| Example 30 | | | | | | |
| Experimental | 2.25 | 3.0 | 30 | 110 | 24 | Z-X + Z-P + |
| Example 31 | | | | | | H.S |
| Experimental | 2.25 | 3.0 | 30 | 120 | 24 | Z-X + Z-P + |
| Example 32 | | | | | | H.S |

* In Table 7, Z-A, Z-X, and Z-P mean A-type zeolite, X-type zeolite, and P-type zeolite, respectively.*
In Table 7, H.S and analcime mean that hydroxysodalite and analcime are mixed and produced in an amount exceeding 0.005 wt %, respectively.

As shown in Table 7, in Experimental Examples 25 to 29 in which a crystallization temperature of hydrogels prepared by using the lithium residue component-adjusted to have a Si/Al molar ratio of 2.25 and a 3.0 M sodium hydroxide (NaOH) solution was adjusted to 60 to 100° C., final products were produced as type-A zeolite, type-X zeolite, and type-P zeolite, which had good crystallinity.

On the contrary, Experimental Example 30 in which the crystallization temperature was adjusted to less than 60° C., a final product that analcime was mixed was produced, but when the crystallization temperature was adjusted to 100° C. in Experimental Examples 31 and 32, final products that hydroxysodalite in addition to the type-X zeolite and the type-P zeolite was mixed were produced.

Accordingly, when the crystallization temperature was adjusted to the range of 60 to 100° C., a zeolite crystal phase with good crystallinity was produced.

(6) Adjustment of Crystallization Time

[Experimental Example 33] It was carried out under the same conditions as in Experimental Example 13, except that the crystallization time was performed for 12 hours. The results are shown in Table 8.

[Experimental Example 34] It was carried out under the same conditions as in Experimental Example 13. The results are shown in Table 8.

[Experimental Example 35] It was carried out under the same conditions as in Experimental Example 13, except that the crystallization time was performed for 48 hours. The results are shown in Table 8.

[Experimental Example 36] It was carried out under the same conditions as in Experimental Example 13, except that the crystallization time was performed for 1 hour. The results are shown in Table 8.

[Experimental Example 37] It was carried out under the same conditions as in Experimental Example 13, except that the crystallization time was performed for 3 hours. The results are shown in Table 8.

[Experimental Example 38] It was carried out under the same conditions as in Experimental Example 13, except that the crystallization time was performed for 6 hours. The results are shown in Table 8.

TABLE 8

| | | Alkali | Alkali | Crystal- | | Produced |
|---|---|---|---|---|---|---|
| | Molar | solution | addition | lization | Crystal- | crystal |
| | ratio | concen- | amount | temper- | lization | phase/ |
| | of | tration | (NaOH ml/ | ature | time | cryst- |
| | Si/Al | (M) | residue g) | (° C.) | (hr) | allinity |
| Experimental | 2.25 | 1.0 | 30 | 90 | 12 | Z-P/Good |
| Example 33 | | | | | | |
| Experimental | 2.25 | 1.0 | 30 | 90 | 24 | Z-P/Good |
| Example 34 | | | | | | |
| Experimental | 2.25 | 1.0 | 30 | 90 | 48 | Z-P/Good |
| Example 35 | | | | | | |
| Experimental | 2.25 | 1.0 | 30 | 90 | 1 | analcime |
| Example 36 | | | | | | |
| Experimental | 2.25 | 1.0 | 30 | 90 | 3 | analcime |
| Example 37 | | | | | | |
| Experimental | 2.25 | 1.0 | 30 | 90 | 6 | analcime |
| Example 38 | | | | | | |

* In Table 8, Z-P means P-type zeolite.*
In Table 8, analcime means that analcime is mixed and produced in an amount exceeding 0.005 wt %.

As shown in Table 8, in Experimental Examples 33 to 35 in which the crystallization temperature of hydrogels prepared by using the lithium residue component-adjusted to have a Si/Al molar ratio of 2.25 and a 1.0 M sodium hydroxide (NaOH) solution was adjusted into 90° C., and crystallization time thereof was adjusted into greater than or equal to 12 hours, a final product was prepared as type-P zeolite with good crystallinity.

On the contrary, when the crystallization time was less than 12 hours in Experimental Examples 36 to 38, final products that analcime was mixed were produced.

Accordingly, the crystallization time was adjusted to the range of 12 hours or more, a zeolite crystal phase with good crystallinity was produced.

(7) Adjustment of the Stirring Rate

[Experimental Example 39] It was carried out under the same conditions as in Experimental Example 13. The results are shown in Table 9.

[Experimental Example 40] It was carried out under the same conditions as in Experimental Example 13, except that the stirring rate was adjusted to 400 rpm to crystallize it. The results are shown in Table 9.

[Experimental Example 41] It was carried out under the same conditions as in Experimental Example 13, except that the stirring rate was adjusted to 500 rpm to crystallize it. The results are shown in Table 9.

[Experimental Example 42] It was carried out under the same conditions as in Experimental Example 13, except that the stirring rate was adjusted to 600 rpm to crystallize it. The results are shown in Table 9.

[Experimental Example 43] It was carried out under the same conditions as in Experimental Example 13, except that crystallization in a stationary state was performed without stirring. The results are shown in Table 9.

[Experimental Example 44] It was carried out under the same conditions as in Experimental Example 13, except that the stirring rate was adjusted to 200 rpm to crystallize it. The results are shown in Table 9.

[Experimental Example 45] It was carried out under the same conditions as in Experimental Example 13, except that the stirring rate was adjusted to 700 rpm to crystallize it. The results are shown in Table 9.

TABLE 9

| | | Alkali | | Crystal- | | |
|---|---|---|---|---|---|---|
| | Molar | solution | | lization | Crystal- | |
| | ratio | concen- | Stirring | temper- | lization | Produced |
| | of | tration | rate | ature | time | crystal phase/ |
| | Si/Al | (M) | (rpm) | (° C.) | (hr) | crystallinity |
| Experimental | 2.25 | 1.0 | 300 | 90 | 24 | Z-P/Good |
| Example 39 | | | | | | |
| Experimental | 2.25 | 1.0 | 400 | 90 | 24 | Z-P/Good |
| Example 40 | | | | | | |
| Experimental | 2.25 | 1.0 | 500 | 90 | 24 | Z-P/Good |
| Example 41 | | | | | | |
| Experimental | 2.25 | 1.0 | 600 | 90 | 24 | Z-P/Good |
| Example 42 | | | | | | |
| Experimental | 2.25 | 1.0 | 0 | 90 | 24 | analcime |
| Example 43 | | | | | | |
| Experimental | 2.25 | 1.0 | 200 | 90 | 24 | analcime |
| Example 44 | | | | | | |
| Experimental | 2.25 | 1.0 | 700 | 90 | 24 | H.S + |
| Example 45 | | | | | | analcime + |
| | | | | | | SOD |

* In Table 9, Z-P means P-type zeolite. *
In Table 9, HS, analcime, and SOD mean that hydroxysodalite, analcime, and SOD are mixed and produced in an amount exceeding 0.005 wt %.

As shown in Table 9, in Experimental Examples 39 to 42 in which the crystallization temperature of hydrogels prepared by using the lithium residue component-adjusted to have a Si/Al molar ratio of 2.25 and a 1.0 M sodium hydroxide (NaOH) solution was adjusted into 90° C., crystallization time thereof was adjusted into 12 hours, and a stirring rate was adjusted into the range of 300 to 600 rpm during the crystallization, final products were produced as type-P zeolite with good crystallinity.

On the other hand, in the case of Experimental Example 43 and Experimental Example 44 in which the stirring was not separately performed or the stirring rate was adjusted to less than 300 rpm, it was confirmed that the analcime was mixed and produced.

In the case of Experimental Example 45 in which the stirring rate was adjusted above 600 rpm, it was confirmed that hydroxysodalite, analcime, and SOD were mixed and produced.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A method of producing zeolite, comprising
obtaining a lithium residue including aluminosilicate from lithium ore including lithium oxide;
washing the lithium residue to adjust the pH of the lithium residue;
adjusting a molar ratio of silicon to aluminum (Si/Al) included in the lithium residue;
preparing a hydrogel by adding an alkali material to the lithium residue; and
preparing crystals by crystallizing the lithium residue in the form of a hydrogel.

2. The method of claim 1, wherein
the obtaining of the lithium residue comprises
heat-treating the lithium ore;
pulverizing the heat-treated lithium ore;
precipitating lithium sulfate from the pulverized lithium ore; and
leaching and separating the lithium sulfate into water.

3. The method of claim 2, wherein
In the heat-treating of the lithium ore,
the lithium ore is heat-treated at a temperature of 900 to 1200° C.

4. The method of claim 1, wherein
in the obtaining of the lithium residue,
the lithium residue comprises
20 to 30 wt % of alumina (Al₂O₃), 60 to 70 wt % of silica (SiO₂), 10 wt % or less of at least one of iron oxide (Fe₂O₃), calcium oxide (CaO), sodium oxide (Na₂O), and potassium oxide (K₂O) based on total 100 wt %.

5. The method of claim 1, wherein
in the adjusting of the pH of the lithium residue,
the lithium residue is washed to remove the sulfate ion (SO₄²⁻) from the lithium residue.

6. The method of claim 1, wherein
in the adjusting of the pH of the lithium residue,
the pH of the lithium residue is adjusted to 6 to 8.

7. The method of claim 1, wherein
in the adjusting a molar ratio of silicon to aluminum (Si/Al),
the molar ratio of silicon to the aluminum (Si/Al) is adjusted to 0.75 to 3.0 by adding an alumina supplement material to the lithium residue.

8. The method of claim 7, wherein
the alumina supplement material comprises
one or more of alumina hydrate (Al(OH)₃ and sodium aluminate (NaAlO₂).

9. The method of claim 1, wherein
in the adding of an alkali material to the lithium residue,
the alkali material is a sodium hydroxide aqueous solution having a concentration of 1.0 to 6.0 M.

10. The method of claim 1, wherein
in the preparing of the crystals,
the lithium residue is crystallized at a temperature of 60 to 100° C.

11. The method of claim 1, wherein
in the preparing of the crystals,
the lithium residue is crystallized for at least 12 hours.

12. The method of claim 1, wherein
in the preparing of the crystals,
the lithium residue in the form of a hydrogel is crystallized while stirring at 300 to 600 rpm.

13. The method of claim 1, which further comprises
filtering the crystals; and
washing and drying the filtered crystals
after the preparing of the crystals.

14. A zeolite having a crystal phase comprising at least one an A-type zeolite, an X-type zeolite, and a P-type zeolite and
comprising 0.005 wt % or less (excluding 0 wt %) of hydroxysodalite (Na₈(AlSiO₆)₄(OH)₂), analcime (NaAlSi₂O₆.H₂O), and SOD based on total 100 wt %.
